(19) United States
(12) Patent Application Publication
(10) Pub. No.: US 2009/0319401 A1
(43) Pub. Date: Dec. 24, 2009

(54) Techniques for efficient allocation of stock items

(75) Inventors: Gopal Rao, Union City, CA (US); Ricardo S. Ambrose, Washington, DC (US); Ben Chihaoui, Castro Valley, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/141,735

(22) Filed: Jun. 18, 2008

(51) Int. Cl. G06Q 10/00

(52) U.S. Cl. 705/29

(57) ABSTRACT

Embodiments of the present invention provide techniques for determining one or more inventory items from an inventory for fulfilling an items order. In one embodiment, one or more sets of inventory items are selected from available inventory to fulfill orders in such a way that a minimum number of inventory item sets are allocated for fulfilling the order. This in turn reduces the number of picks that must be made when gathering inventory items for an order. The inventory items sets may include standard pack quantities and/or indivisible items.

### BACKGROUND OF THE INVENTION

The present invention relates generally to inventory management systems and in particular to techniques for allocating inventory items to fulfill orders.

Inventory management systems facilitate the monitoring of the quantity, location and status of inventory items. Inventory items may include any kind of physical asset, such as merchandise to be sold by a retailer. Conventional inventory management systems often include functionality for receiving of inventory items, for storing the inventory items in a storage facility, such as a warehouse (putaway processing), for tracking of orders from customers requesting one or more of the inventory items, and for selecting inventory items to be used to fulfill orders (picking).

Inventory items may be received and/or stored in a warehouse or other storage facility in various sized lots, or sets, of inventory items. For example, inventory items may be received and/or stored at the warehouse in standard pack quantities (SPQs). Standard pack quantities are predetermined numbers of inventory items that are shipped together as a package, such as by the case, by the box, or by other predetermined number of inventory items. An inventory may be offered for purchase in various sized standard pack quantities, and the number of inventory items that comprise a standard pack quantity may vary for different types of inventory items and/or for inventory items from different manufacturers. Standard pack quantities may be broken down into smaller subsets of inventory items and/or into individual inventory items for storage in the warehouse and/or when picking inventory items to fulfill orders.

Inventory items may also be received and/or stored in user-grouped sets of inventory items that comprise a plurality of individual inventory items grouped together into manageable units. User-grouped sets of inventory items may comprise standard pack quantities, non-standard pack quantities, or individual inventory items grouped together to form an inventory item set. For example, inventory items may be palletized to facilitate handling and storage of the inventory items by shipping and/or warehouse personnel. Pallets of inventory items can be shipped and stored together as a unit rather than having to ship and store individual each of the individual inventory items as a separate unit. Like SPQs, user-grouped sets of inventory items may be broken down into smaller subsets of inventory items and/or into individual inventory items for storage in the warehouse and/or when picking inventory items to fulfill orders.

Some inventory items may also be received and/or stored in indivisible lots. Indivisible lots, unlike the SPQs or user-grouped sets of inventory items described above, cannot be broken down into smaller sets of inventory items when picking inventory items to fulfill orders. For example, an indivisible inventory item may comprise 921 feet of steel cable stored on a spool, the entire spool of 921 feet of steel cable would be sold in its entirety, because it would be impractical to subdivide the spool of wire into smaller lengths of wire at the warehouse. As another example, a batch of microprocessors may be treated as an indivisible inventory item, and the entire batch will be sold only in its entirety.

As indicated above, inventory items are often stored in a warehouse or other storage facility, and warehouse personnel, or in some instances, automated inventory systems, must gather (pick) inventory items or sets of inventory items from various storage locations in the warehouse or storage facility to fulfill each order. Picking of inventory items allocated to an order can be a labor intensive process, and conventional inventory managements systems do not provide for efficient handling of inventory items stored in standard pack quantities and indivisible quantities to minimize the number of picks that must be made when gathering inventory items allocated to an order. Consequently, due to inefficient allocation and picking of inventory items, warehouse operations may be significantly impacted resulting in slower order processing and fulfillment. Accordingly, techniques that provide for more efficient allocation of inventory items to orders are desired.

### BRIEF SUMMARY OF THE INVENTION

Embodiments of the present invention provide techniques for determining one or more inventory items from an inventory for fulfilling an items order. In one embodiment, one or more sets of inventory items are selected from available inventory to fulfill orders in such a way that a minimum number of inventory item sets are allocated for fulfilling the order. This in turn reduces the number of picks that must be made when gathering inventory items for an order. The inventory items sets may include standard pack quantities and/or indivisible items.

According to an embodiment of the present invention, a method for allocation of inventory is provided. The method includes receiving a request for one or more inventory items, and accessing available inventory information identifying a plurality of inventory items available for fulfilling the request. The plurality of inventory items are grouped into one or more inventory item sets and inventory item set comprises one or more inventory items. Each inventory item set also has a divisibility indicator associated with it that indicates whether a breakup of the inventory item set into one or more subsets is permitted. The method also includes selecting inventory item sets from the inventory information that may be used to fulfill the inventory request with a minimum number of inventory item sets, and outputting the grouping of inventory sets to be gathered to fulfill the request.

According to another embodiment of the present invention, an inventory management system is provided. The inventory management system is configured to receive a request for one or more inventory items, and access available inventory items data identifying available inventory items. The available inventory items may be grouped into inventory sets comprising one or more inventory items. Each inventory set comprises one or more inventory items, and each inventory set includes an indicator includes a divisibility indicator that indicates whether the inventory item set may be divided into one or more subsets. The inventory management system further is further configured to determine inventory sets from the available inventory that may be used to fulfill the inventory request. The inventory management system is also configured to select a grouping of inventory sets from the available inventory that satisfies the inventory request with a minimum number of inventory sets. The inventory sets may be located in a plurality of locations within the warehouse. The inventory management system also configured to output the grouping of inventory sets to be gathered to fulfill the request.

According to another embodiment of the present invention, an inventory management system is provided. The inventory management system is configured to receive a request for one or more inventory items and to access available inventory information identifying a plurality of inventory items available for fulfilling the request. The plurality of inventory items may be grouped into one or more inventory item sets and each inventory item set comprises one or more inventory items. Each inventory set may comprise one or more inventory items, and each inventory set includes an indicator includes a divisibility indicator that indicates whether the inventory item set may be divided into one or more subsets. The inventory management system is further configured to determine inventory item sets from the inventory information that may be used to fulfill the inventory request with a minimum number of inventory item sets and to output the inventory sets to be gathered to fulfill the request.

According to another embodiment of the present invention, a computer readable medium storing a plurality of instructions for controlling a data processor to perform one or more tasks. The plurality instructions includes an instruction that causes the data processor to receive a request for one or more inventory items and an instruction that causes the data processor to access available inventory information identifying a plurality of inventory items available for fulfilling the request. Each inventory set may comprise one or more inventory items, and each inventory set includes an indicator includes a divisibility indicator that indicates whether the inventory item set may be divided into one or more subsets. The plurality of instructions further comprise an instruction that causes the data processor to determine inventory item sets from the inventory information that may be used to fulfill the inventory request with a minimum number of inventory item sets, and an instruction that causes the data processor to output the inventory sets to be gathered to fulfill the request.

Other features and advantages of the invention will be apparent in view of the following detailed description and preferred embodiments.

### BRIEF DESCRIPTION OF THE DRAWINGS

FIG. 1 is an illustration of the layout of a typically warehouse for storing inventory items.

FIG. 2 is a flowchart illustrating a method for allocating inventory items to fulfill a request according to an embodiment of the present invention.

FIG. 3 is a flowchart illustrating a method for allocating inventory items stored in standard pack quantities and user-defined quantities to satisfy an order according to an embodiment of the present invention.

FIG. 4 illustrates allocating inventory items to satisfy an order for inventory items stored in standard pack quantities and user-defined quantifies according to the method illustrated in FIG. 3 according to an embodiment of the present invention.

FIG. 5 is a flowchart illustrating a method for allocating indivisible inventory item sets to satisfy an order according to an embodiment of the present invention.

FIGS. 6A and 6B illustrate allocating indivisible inventory items to satisfy an order comprising indivisible inventory item sets according to the method illustrated in FIG. 5.

FIG. 7 is a block diagram of an computer system that can be used to implement the techniques for efficiently allocating inventory items described above according to an embodiment of the present invention.

FIG. 8 is a block diagram of an inventory management system according to an embodiment of the present invention.

Embodiments of the invention are described here, with reference to the figures. Where elements of the figures are called out with reference numbers, it should be understood that like reference numbers refer to like elements and might or might not be the same instance of the element.

### DETAILED DESCRIPTION OF THE INVENTION

In the following description, for the purposes of explanation, specific details are set forth in order to provide a thorough understanding of the invention. However, it will be apparent that the invention may be practiced without these specific details.

Embodiments of the present invention provide techniques for selecting inventory items from available inventory to fulfill orders with a minimum number of inventory item sets in order to reduce the number of picks that must be made when picking inventory items for an order. The inventory items sets may include standard pack quantities, user-grouped sets, and/or indivisible items.

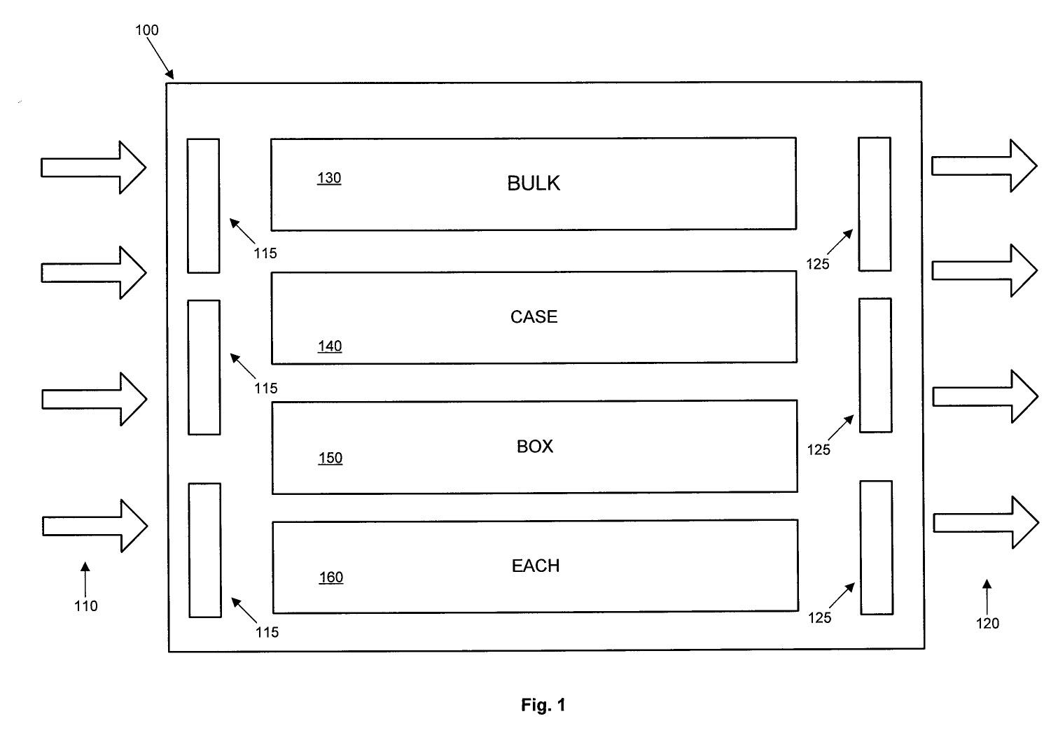

FIG. 1 illustrates a layout of a warehouse 100 for storing inventory according to an embodiment of the present invention. Incoming stock items 110 are received in receiving areas 115. Incoming stock items 110 are inventory items that are being sent for storage in warehouse 100. In the embodiment depicted in FIG. 1, incoming stock items 110 are sorted and stored in four rows along the length of warehouse 100. Each row of stock is separated by an aisle to facilitate the placement of incoming inventory items and the removal of inventory items being gathered to fulfill orders.

Row 130 is used to store bulk inventory items sets. Bulk inventory item sets typically include larger quantities of inventory items grouped together to facilitate shipping and/or storage of the inventory items. Bulk inventory item sets may comprise multiple sets of inventory items grouped into standard-pack quantities and/or may also include user-grouped sets of inventory items that are not grouped into standard pack quantities. For example, a bulk storage area of a warehouse might include standard pack quantities of widgets, such as boxes and/or cases of widgets, that have been palletized (multiple cases and/or boxes of widgets shrink-wrapped together and stored on a pallet). Bulk item storage may also include indivisible lots of inventory items, such as bales of wire or batches of microprocessors, that are sold only in their entirely. Each indivisible inventory item is assigned a unique identifier—a license plate number (“LPN”)—when the indivisible inventory item is received at the warehouse.

In the embodiment depicted in FIG. 1, rows 140 and 150 are used to store standard pack quantities. As an example, a soft drink may be stored available in six packs—standard pack quantities comprising six containers, such as cans or bottles, of the soft drink. An inventory item may be available in more than one standard pack quantity. For example, soft drinks may be available both in six packs comprising six containers of the soft drink and in cases comprising 24 containers of the soft drink. Row 140 may be used to store cases of inventory items. Each case may include multiple boxes of inventory items. Row 150 may be used to store boxes of inventory items. Each box may include multiple inventory items.

Row 160 may be referred to as “each” storage, because individual inventory items comprising the smallest saleable stock unit are stored in this storage area. Some bulk items and/or standard pack quantities may be broken up into smaller units and/or into individual inventory items. Ideally, however, the standard pack quantities and bulk items will not be divided up unless necessary to fulfill an order. Furthermore, according to an embodiment of the present invention, a divisibility tag may be associated with each inventory item sets that indicates whether the inventory item set is divisible.

To illustrate how warehouse 100 might be used, the following example is provided. According to an embodiment of the present invention, warehouse 100 may be used by a mobile phone manufacturer to store phones to be shipped to various retailers. The manufacturer delivers the mobile phones to warehouse 100 and the entering stock 110 of mobile phones are brought into receiving areas 115 to be sorted and stored. Some of the mobile phones arrive at the warehouse palletized in order to facilitate handling. Each pallet may include 10 cases of mobile phones, each case including 10 boxes of mobile phones, and each box including 10 individual mobile phones. Thus, each case includes 100 mobile phones and each pallet includes 1000 mobile phones. As the pallets of inventory items are received, some of the pallets may be stored in bulk storage 130, while other pallets of mobile phones may be subdivided into cases and stored in row 140. Some of the cases may also be broken down into boxes and the boxes stored in row 150. Furthermore, some of the boxes may be broken down into individual mobile phones and the individual mobile phones stored in row 160.

When an order is received, inventory items are allocated to the order and these inventory items are gathered from one or more storage areas of the warehouse. This gathering process is also known as “picking” the inventory items. According to an embodiment of the present invention, the picking process may be performed by warehouse personnel who manually gather items from one or more areas of the warehouse in order to fulfill orders. According to other embodiments, the picking process may be automated, where a mechanical or robotic inventory retrieval system gathers inventory items from the warehouse. The gathered items are taken to fulfillment areas 125 where the orders are assembled. Outgoing orders are shipped to customers as outgoing shipments 120.

One skilled in the art will recognize that the layout of warehouse 100 illustrated in FIG. 1 is merely one example of a warehouse that may be used with embodiments of the present invention.

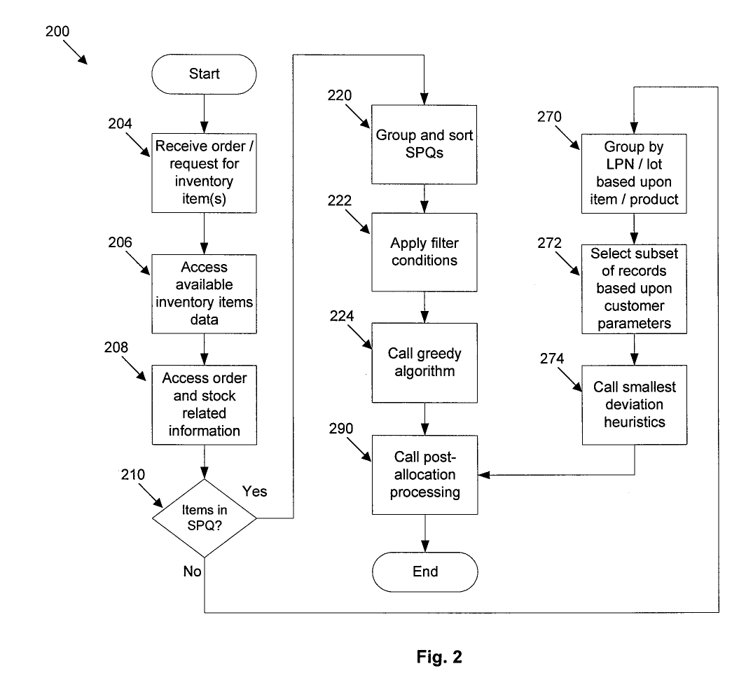

FIG. 2 is a flowchart illustrating a method 200 for allocating inventory items for an order according to an embodiment of the present invention. Method 200 begins with step 204. At step 204, a request or order for an inventory item or items is received. For sake of simplicity and clarity in describing an embodiment of the present invention, it is assumed that the request received in 204 is for a single type of inventory item. This is however not intended to limit the scope of the present invention. In alternative embodiments, a request may be received for multiple types of inventory items. For example, an order may be received for fifty laptop computers or for one thousand meters of copper cable, and the like.

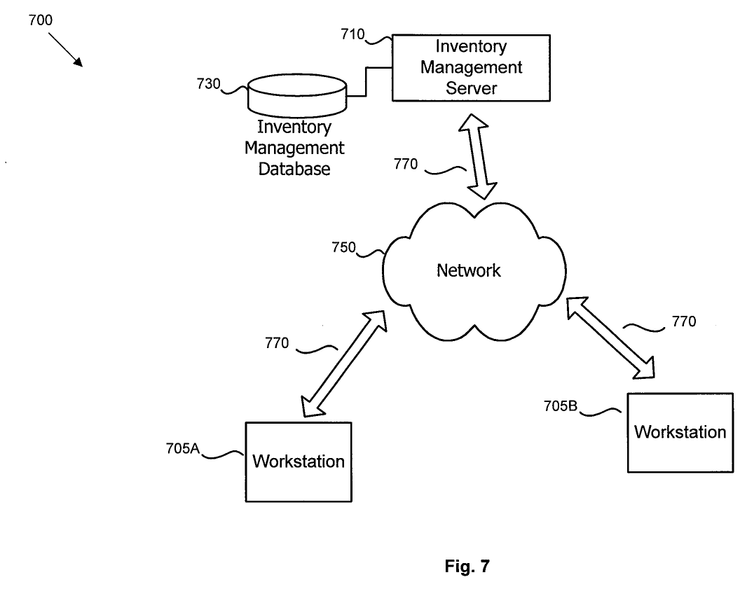

At step 206, available inventory items data is accessed. According to an embodiment of the present invention, available inventory items data may be stored in a relational database, such as an inventory item database (e.g., inventory item database 730 depicted in FIG. 7 and described below). In alternative embodiments, the available inventory items data may be maintained in multiple relational databases and/or may be stored on multiple remote and/or local data servers.

According to an embodiment of the present invention, the available inventory items data may be selected based upon a set of predefined picking rules. The order is processed using the picking rules and the rules engine selects available inventory that satisfies the picking rules. The rules engine may, for example, construct and execute queries to retrieve available inventory items data from a relational database storing inventory data. According to an embodiment of the present invention, available inventory items data is gathered by the rules engine and is then provided to an allocation module that is configured to select inventory items from the available inventory items data to be allocated to the order.

At step 208, additional stock-related information and order-related information is accessed. For instance, the additional information may include units of measure for the inventory items ordered. As an example, computer microprocessors might be ordered in batches comprising one or more microprocessors, while steel cable might be sold in spools measured in liner feet or meters of cable. Other information, such as order tolerances may also be accessed, such as maximum and minimum thresholds on the number of inventory items that may be allocated to an order. Tolerances may, according to some embodiments, be specified with the order and/or may be obtained from customer profile information associated with the customer that made the request for inventory items received in step 204. Customer profile information may be stored in the inventory management system, such as in. For example, a customer profile may specify tolerances for one or more specific types of inventory items while providing default tolerances that may be applied to orders for other types of inventory items. The additional stock-related information and order-related information may be stored in a database, such as inventory item database 730, described below.

At step 210, a determination is made whether the inventory item or items requested in step 204 are stored in the warehouse in standard pack quantities or user-grouped sets of inventory items. When allocating items to fulfill an order, different allocation methods may be used for inventory items stored in the storage facility in standard pack quantities or user-grouped sets of inventory items than for inventory items stored in the storage facility in indivisible units. For items stored in the warehouse in standard pack quantities or user-grouped sets of inventory items, a greedy allocation method may be used to allocate inventory items to fulfill an order. According to the greedy allocation method, inventory items are allocated in on or more iterations, and at each iteration, a largest available set of inventory items that is less than or equal to the remaining number of inventory items to be allocated in response to the request are allocated to the request. The set of inventory items that may comprise a standard pack quantity, a user-grouped sets of inventory items, or an individual inventory item. Iterations are performed until the requested number of inventory items are allocated to the order (or quantity of inventory items within an acceptable threshold has been allocated) or no more available inventory is available to allocate to the order.

In contrast, if the requested inventory item or items are stored in the warehouse in indivisible lots, a minimum deviation heuristic allocation method may be used to allocate inventory items to fulfill an order. According to the minimum deviation heuristic allocation method, indivisible inventory items are allocated in one or more iterations, and at each iteration, a set of indivisible inventory items are considered and one or more indivisible inventory items are allocated from the set of indivisible inventory items. Iterations are performed until the requested number of inventory items are allocated to the order (or quantity of inventory items within an acceptable threshold has been allocated) or no more available indivisible inventory items are available to allocate to the order. Thus, unlike the greedy allocation method, where a largest inventory item set is selected at each iteration, multiple indivisible inventory items may be allocated at each iteration of the minimum deviation heuristic allocation method.

If the inventory items requested are stored in the warehouse in standard pack quantities or user-grouped sets of inventory items, method 200 proceeds to step 220 where available inventory items that are stored in standard pack quantities or user-grouped sets of inventory items are allocated to the order. Otherwise, process 200 continues to step 270 where inventory items stored in indivisible lots or non-standard pack quantities are allocated to the order.

At step 220, the available inventory items data accessed in step 206 is grouped by warehouse zone and by location identifier. Location identifiers are unique identifiers associated with a physical storage location within a warehouse or other storage facility. According to various embodiments of the present invention, the granularity of the location identifiers may vary. For example, according to one embodiment of the present invention, a location identifier may be associated with a particular aisle of storage in a storage facility, while in other embodiments of the present invention, the location identifier may be used to identify a specific storage bin on a particular shelf of a particular aisle of the storage facility.

Location identifiers facilitate picking of items in the warehouse (or any storage facility) by identifying the physical locations in the warehouse or storage facility where one or more items allocated to fulfill an order can be found in the warehouse. According to some embodiments, location identifiers may be used by warehouse personnel to manually pick inventory items that have been allocated to an order. In other embodiments, location identifiers may be used by an automated system to pick inventory items from storage locations in the storage facility identified by location identifiers. After the completion of step 220, method 200 continues with step 222.

At step 222, a predetermined set of one or more predetermined filter conditions may be applied to the available inventory items data determined in 206 to reduce the amount of inventory items data used for further processing. Application of the filter conditions is intended to eliminate records that fall outside of the filter conditions thereby reducing the information used to perform allocation processing. This improves the speed and efficiency of the allocation process. When determining whether to eliminate a record, the filter conditions consider the available inventory in terms of standard pack quantities or user-defined quantities. For example, if a record indicates that 200 available widgets are available, and that the widgets are stored in boxes of 10 widgets each, then 20 boxes of widgets would be available for allocation. The filter conditions would treat each box as an indivisible inventory item to be allocated as a whole when determining whether to eliminate a record.

Various different types of filter conditions and/or combinations of filter conditions may be applied. In one embodiment, the filter conditions eliminate records where the total number of indivisible inventory items is greater than an allowable maximum threshold associated with a request for inventory items so that those records will not be considered upon execution of the greedy allocation method. In another embodiment, the filter conditions eliminate records where the available quantity that is less than the requested number of inventory items. The available quantity for a record may be less than the number of inventory items represented by the record, because inventory items may have been allocated to another order and/or may have been picked (e.g., moved to fulfillment areas 125 where inventory items are assembled for delivery to customers). The selection process of method 200 may be performed in multiple iterations and the number of available inventory items may decrease due to allocation and/or picks of available inventory items as well as putting away of inventory items (e.g., introduction of additional inventory items into storage locations in the warehouse or movement of inventory items between storage areas). Accordingly, after step 222, a set of filtered available inventory items data remains comprising data for inventory items that satisfy the filter conditions. This filtered inventory items data will be processed by the greedy allocation method.

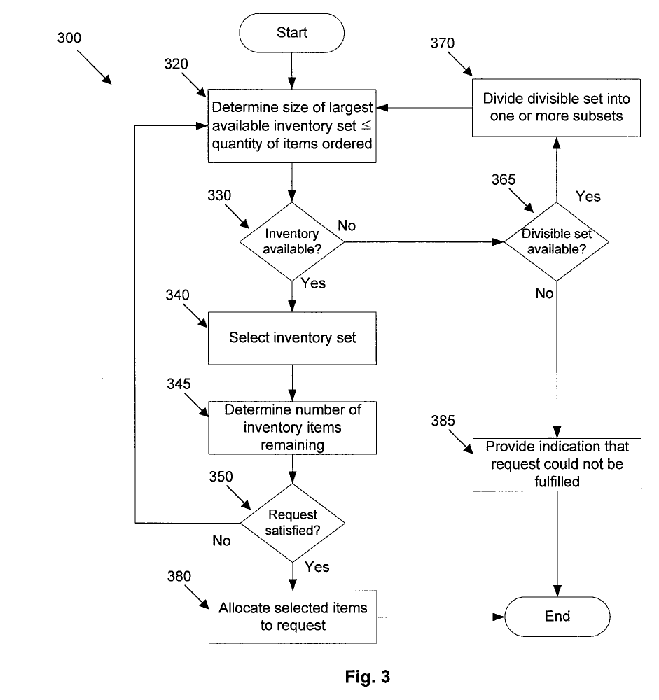

At step 224, a greedy allocation method is applied to the filtered inventory items data determined in 222 to determine one or more inventory items to be allocated to fulfill the request received in step 204. An implementation of a greedy allocation method according to an embodiment of the present invention is illustrated in FIG. 3 and is described below. After completing step 224, method 200 continues with step 290.

At step 270, the available inventory items data accessed in step 206 is sorted by a unique identifier and by location identifier, such as a warehouse zone. As described above, each indivisible inventory item is assigned a unique identifier—a license plate number (“LPN”)—when the indivisible inventory item is received at the warehouse. Each indivisible inventory item is also associated with an inventory units value that indicates the number of inventory units that comprise the indivisible inventory item. The inventory units value is used to measure and compare indivisible inventory items for possible allocation in response to a request for inventory items stored in indivisible lots. Different types of inventory units may be used for different types of indivisible inventory items. As an example, a warehouse may store spools of steel cable that sold by length (e.g. in meters or feet) where the spools are sold only in their entirety. As another example, a warehouse may store batches of microprocessors where the number of microprocessors in each batch may vary and where the batches are sold only in their entirety. The inventory units in this is example is a microprocessor and each batch may comprise one or more microprocessors.

Every LPN is also associated with a location identifier that identifies the physical location in the storage facility where the indivisible inventory item or non-SPQ inventory items is stored. The location in the storage facility facilitates picking of indivisible inventory item or non-SPQ inventory items allocated to an order. After completing step 270, method 200 continues with step 272.

At step 272, a subset of the available records are selected based upon a set of preferences associated with the customer that made the request for the inventory items received in step 204. The user preferences may include a maximum and/or a minimum number of inventory units that a customer will accept. A customer may elect to receive more or less than the number of inventory items requested in an order. The maximum number of inventory units provides an upper limit on the number of inventory items that the customer will accept for an order. According to an embodiment, the maximum and minimum number of inventory items that a customer may accept may be defined as percentages. For example, according to one embodiment of the present invention, the maximum number of inventory units that a customer will accept may be set to 20% more than the number of inventory units requested in an order. Likewise, the minimum number of inventory units that the customer will accept may be set to 10% less than the number of inventory units requested in an order. Thus, if the customer requests 100 units of a particular inventory item, the customer would accept anywhere between 90 and 120 inventory units for fulfilling that request. After completing step 272, method 200 continues with step 274.

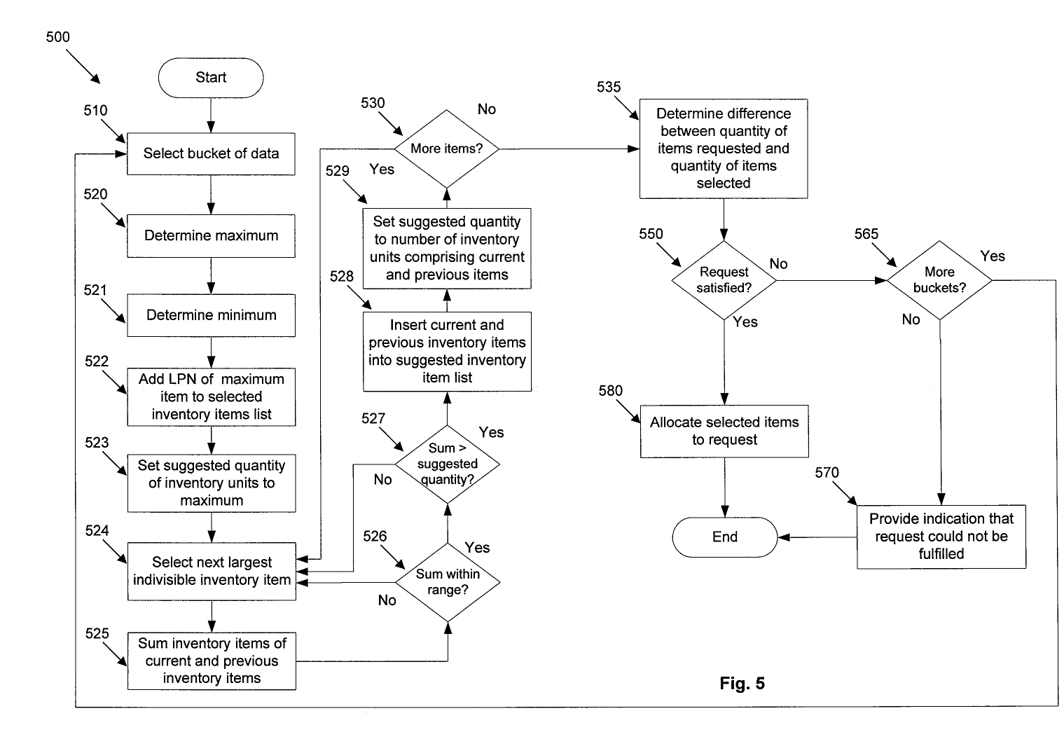

At step 274, minimum deviation heuristic allocation method logic is executed to select indivisible inventory items to be allocated to fulfill the request received in step 204. An implementation of minimum deviation heuristic allocation method according to an embodiment is illustrated in FIG. 5 and is described in detail below. After completing step 274, method 200 continues with step 290.

After steps 224 and 274, the order received in 204 has been allocated inventory items to fulfill the order. At step 290, post-allocation processing logic may be performed. Post-allocation processing may include informing warehouse personnel and/or an automated inventory item retrieval system to retrieve inventory items that have been selected to fulfill the order received in 204. In case where the order could not be successfully fulfilled, processing in step 290 may also involve providing an indication that the request could not be fulfilled from the available inventory. A reason why the order could not be fulfilled may also be provided. After completing step 290, method 200 terminates.

FIG. 3 is a flowchart illustrating a method 300 for allocating inventory items to an order stored in standard pack quantities and/or user-defined quantities using a greedy allocation method according to an embodiment of the present invention. Method 300 may be performed by software (e.g. computer program code) executed by a processor, by hardware, or a combination thereof.

Method 300 begins with step 320. According to an embodiment, prior to entering method 300, available inventory item data is accessed, such as in step 206 of method 200, and the available inventory item data is grouped by warehouse zone and by location identifier such as in step 220 of method 200, described above. For example, the available inventory data may be grouped into sets corresponding to bulk storage, case storage, box storage, and “each” storage areas of a storage facility, such as is illustrated in FIG. 1.

According to an embodiment of the present invention, the available inventory items data used by method 300 may be presorted to facilitate processing and to minimize the number of picks necessary to gather the inventory items allocated to the order. For example, the inventory items may be sorted on the sizes of the standard pack quantities or user-defined quantities. For example, in one embodiment, sorting may be performed in descending order by the number of inventory in each standard pack quantity or user-defined quantity such that standard pack quantities and/or user-defined quantities with larger sizes are towards the head of the sorted order and those with smaller sizes are towards the tail of the sorted order. This helps to minimize the number of individual inventory item sets that must be picked after allocation is complete.

As described above, inventory items are allocated in on or more iterations according to the greedy allocation method, and at each iteration, a largest available set of inventory items that is less than or equal to the remaining number of inventory items to be allocated in response to the request are allocated to the request. The set of inventory items that may comprise a standard pack quantity, a user-grouped sets of inventory items, or individual inventory items. Iterations are performed until the requested number of inventory items are allocated to the order (or quantity of inventory items within an acceptable threshold has been allocated) or no more available inventory is available to allocate to the order.

In step 320, a largest available inventory item set size comprising a number of inventory items less than or equal to the number of inventory items remaining to be allocated to the order is identified. This is done to minimize the number of picks that will need to be made when gathering the inventory items allocated to the order. This also avoids having to unnecessarily break up larger inventory item sets, which is labor intensive and inefficient because any remaining inventory items from larger inventory item sets that are not allocated to the order would have to be moved to an appropriate storage location in the warehouse and the location information associated with those items would also need to be updated.

For example, let's assume that an order is received for 48 widgets and the inventory to be used for fulfilling the order is stored in a warehouse with a layout similar to that described in FIG. 1. For example, the warehouse may be divided into four storage areas: an area for storing bulk inventory item sets (row 130), an area for storing cases of 50 widgets (row 140), an area of storing boxes of 10 widgets (row 150), and an area for storing individual inventory items. In this scenario, inventory item sets from the bulk storage area 130 comprising 500 items each and inventory item sets from the case storage area 140 comprising 50 items each would not be considered in step 320 for allocation to the order because the size of each inventory item set (i.e., the number of inventory items in the inventory item set) stored in 130 and 140 is larger than the number of inventory items requested in the order. Instead, inventory item sets stored in box storage area 150 comprising 10 items each and individual inventory items stored in “each” storage area 160 would be considered for allocation to the order. The available inventory item sets from bulk storage area 130 and case storage area 140 are initially ignored, because breaking up of larger sets of inventory items to satisfy orders for smaller quantities of items may be extremely inefficient. For example, if a bulk inventory item set were broken up to satisfy the order for 48 inventory items, the remaining 452 inventory items would have be moved to other storage areas within the warehouse and the location information related to those items would have to be updated. The remaining 452 inventory items might be broken up into 9 cases of 50 inventory items each to be stored and in case storage area 140 and the remaining 2 inventory items placed in “each” storage area 160, or the remaining inventory items might be broken up into 45 boxes of 10 items each and stored in box storage area 150 with the remaining 2 inventory items stored in “each” area 160.

Upon completing step 320, method 300 proceeds to step 330 where a determination is made whether any available inventory item sets were identified in step 320. If no available inventory items sets were identified, method 300 proceeds to step 365. Otherwise, method 300 proceeds to step 340.

At step 340, an inventory item set is selected from the available sets of inventory items. As described above, a largest available inventory item set is selected. For example, if 48 widgets are ordered and the available inventory comprises at least 2 cases of 50 widgets each, four boxes comprising 10 widgets each, and 100 individual widgets stored in the “each” are of the warehouse, the largest available set size that would be selected would be boxes. The largest available inventory item set size identified in step 320 would be boxes. Thus, in step 340 an available box of widgets would be selected for allocation to the order.

In an embodiment of the present invention, when an inventory item set is selected, the inventory set is marked in the system as “selected” so that the inventory set is not accidentally allocated to another request while the current request is being processed. After completing step 340, method 300 proceeds to step 345.

At step 345, the number of units that still need to be allocated in order to fulfill the order are determined. In one embodiment, this is done by aggregating the number of units in the inventory sets that have already been selected for the order in 340 and subtracting the aggregated quantity from the quantity of inventory items requested in the order. Method 300 then proceeds to step 350.

At step 350, a determination is made whether the order had been completely fulfilled. In one embodiment, the order is considered to be completely fulfilled if the number of inventory items selected for the order is equal to the items requested in the order. According to some embodiments of the present invention, the order may be considered to be fulfilled if the number of inventory items selected for the order falls within a maximum and/or minimum threshold associated with the request for inventory items.

As previously indicated, in some embodiments of the present invention, a maximum and/or a minimum threshold may be associated with the request for inventory items and these thresholds may be considered in step 350 in determining whether the request has been completely fulfilled. A minimum threshold indicates that the customer will accept less than the requested number of inventory units so long as the quantity of inventory units provided is greater than or equal to the minimum threshold value. A maximum threshold indicates that the customer will accept more than the requested quantity of inventory units so long as the quantity of inventory units provided is less than or equal to the maximum threshold value. In one embodiment, the maximum and minimum thresholds may be expressed in terms of a number of inventory items over or under the requested amount that the customer will accept (e.g., ±5 items, etc.). According to other embodiments of the present invention, minimum and maximum thresholds may be expressed as a percentage of the inventory items requested. If the threshold value for the order is met, the order will be shipped with whatever inventory items have been selected for the order, regardless of whether the additional stock is available in a sufficient quantity of stock to fully supply the requested quantity of inventory items. In some embodiments of the present invention, the minimum and maximum thresholds are only considered if the exact number of items requested in the request for inventory items may not be provided based upon available inventory.

If it is determined in 350 that the order has been satisfied, then in step 380 the selected inventory sets are allocated to the request and the process terminates. If it is determined in 350 that the order has not been satisfied, then method 300 returns to step 310. Otherwise, method 300 proceeds to step 380.

Returning now to step 330, if no inventory item sets of the size selected in step 320 are available for allocation to the order, then method 300 proceeds to step 365 where a determination is made whether a inventory item set larger than the number items to required fulfill the order is available that is also divisible. An inventory item set divisible if it could be subdivided into a one or more smaller inventory item sets. For example, referring back to FIG. 1, if a inventory item set from the bulk storage area comprising 500 inventory items is available and the inventory item set is marked divisible, the inventory item might be subdivided into 10 cases, 50 boxes, into 500 individual inventory items, or a combination of cases, boxes and/or individual inventory items. According to an embodiment of the present invention, a divisibility tag may be associated with each inventory item set that indicates whether the inventory item set is divisible. Furthermore, according to an embodiment of the present invention, method 300 may select an inventory item set to be subdivided that includes a number of inventory items that is closest to the number of inventory items required to fulfill the order.

If a divisible inventory item set is determined to be available in step 365, then method 300 proceeds to step 367 where an inventory item set is selected to be subdivided. According to an embodiment of the present invention, a divisible inventory item set to be subdivided is selected based upon the number of items remaining to be allocated to an order. For example, if an order is received for 48 widgets and bulk inventory storage area has 10 available bulk inventory item sets comprising 500 widgets each, and bulk inventory storage area has 5 available cases of 50 widgets each, the greedy allocation method logic may select one of the available cases of 50 widgets each rather than a bulk inventory item set in order to minimize the amount of labor that would be required to break up a divisible inventory item set. If one of the available cases of widgets is broken up into four boxes of 10 widgets each and 10 individual widgets, only two widgets would remain that would need to be moved from the case storage to the “each” storage once the case of widgets was broken up. If a bulk inventory item set were instead selected to be broken up, breaking up the bulk inventory item set would be significantly more labor intensive than breaking up a case. A bulk inventory item set in the present example includes 500 widgets. After allocating 48 of the 500 widgets to the request, 452 widgets would be left over from the original bulk inventory item set. The 452 widgets would need to be subdivided into one more inventory item sets and moved from the bulk storage area to other storage areas within the warehouse. For example, the 452 widgets might be broken up in to 9 cases of 50 widgets and with 2 widgets left over. The cases would need to be moved to the case storage area of the warehouse and other 2 widgets would need to be moved to the “each” storage area of the warehouse.

If a divisible inventory set is determined to be available in step 365, then the method 300 proceeds to step 370 where the inventory item set selected in step 367 is subdivided into multiple subsets.

Otherwise, if no divisible inventory set is determined to be available in step 365, then the order cannot be fulfilled based upon the available inventory and method 300 ends. The inventory management system may automatically generate a message to warehouse personnel and/or to the client placing the order that the insufficient inventory is currently available to fulfill the order (step 385). In some embodiments of the present invention, the unfulfilled order may be placed in a backordered status for later fulfillment when available inventory increases.

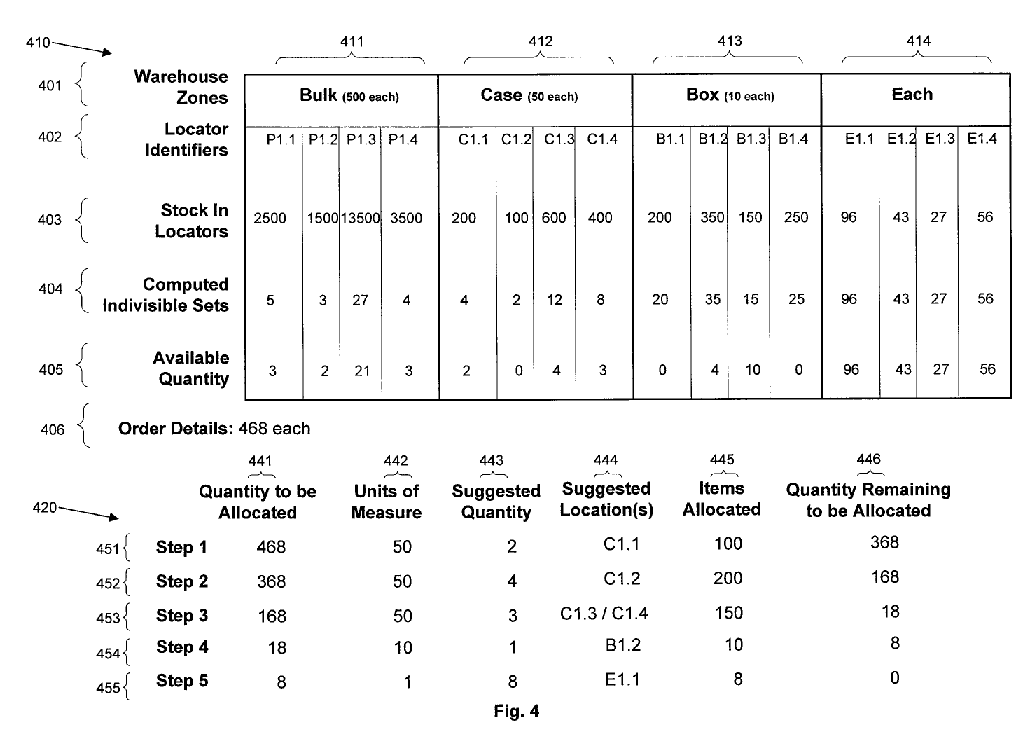

FIG. 4 provides an example showing the results of applying method 300 to allocate inventory items to satisfy an order for inventory items stored in standard pack quantities and/or user-defined quantities according to an embodiment of the present invention. An order 406 is received for 468 inventory units (step 204). In response to receiving the order, available inventory items data is accessed (step 208). The inventory information is broken down by warehouse zones similar to those described in FIG. 1 in order to facilitate the allocation process. One skilled in the art will recognize that the storage locations and groupings of inventory items described in FIG. 1 are merely illustrative and that embodiments may include different grouping and storage locations than those described.

Table 410 provides an illustration of the available inventory items data that might be accessed according to an embodiment of the present invention. As depicted in FIG. 4, inventory information for inventory item sets from bulk storage (each bulk storage comprising 500 items) is displayed in column 411, inventory information for inventory item sets comprising cases of inventory items (each case comprising 50 items) is displayed in column 412, inventory information for inventory item sets comprising boxes of inventory items (each box comprising 10 items) is displayed in column 413, and “each” inventory items sets for inventory items stored individually is displayed in column 414.

Table 410 may comprise multiple rows. Row 401 comprises information identifying the warehouse zone locators, which correspond to the bulk, case, box and “each” storage areas illustrated in FIG. 1. Row 402 stores information identifying location identifiers that indicate a physical storage locations within each of the warehouse zones for each of the inventory item sets. In one embodiment, warehouse zones may be subdivided into multiple physical locations and each physical location may be provided a unique location identifier to facilitate picking of inventory items stored in the location. For example, the information depicted in FIG. 4 indicates that bulk warehouse zone 411 has four associated location identifiers P1.1, P1.2, P1.3, and P1.4 associated with four physical locations within warehouse zone 411 in which inventory item sets might be stored.

Row 403 stores “stock in locators total” information that identifies a total number of inventory items stored at a specific physical location within the warehouse for each warehouse zone and subzone. For example, the information depicted in FIG. 4 indicates that 2500 inventory items are stored at location P1.1 of the bulk warehouse zone, 1500 inventory items are stored at location P1.2 of the bulk warehouse zone, 13500 inventory items are stored a location P1.3 of the bulk warehouse zone, and 3500 inventory items are stored at location P1.4 of the bulk warehouse zone.

Row 404 stores information identifying a number of computed indivisible sets for each location in the warehouse. The a number of computed indivisible sets indicate the number of inventory item sets that comprise the stock in locators total provided in row 403. The number of computed indivisible sets is determined by dividing the stock in locators total (row 403) by the size of the inventory sets that are stored in a particular location. For example, the stock in locators value associated with location P1.1 indicates that 2500 inventory items are stored at location P1.1. Each inventory item set in the bulk storage area comprises 500 inventory items. Therefore, the number of computed indivisible sets in row 404 for location P1.1 is equal to 5 inventory sets.

Row 405 stores information identifying an available quantity. The available quantity indicates the number of computed indivisible sets from row 404 that are actually available to be allocated to orders. The difference between the information in row 404 and row 405 is that row 404 identifies the total number of computed indivisible sets stored at a location while row 405 identifies only those computed indivisible sets that are available to be allocated to an order. An inventory item set may be unavailable because it has been allocated (or is in the process of being allocated) to another order. In order to avoid allocating inventory item sets to multiple orders, inventory item sets are marked as unavailable when they are allocated to an order. According to an embodiment of the present invention, inventory item sets are provisionally marked as “selected” as method 300 selects inventory items to be allocated to the order, and the status of the inventory items is changed to “allocated” if the selection process is successful and the request is satisfied. If the allocation process fails, the inventory item sets provisionally marked as “selected” are again marked as “available” to allow these inventory item sets to be allocated to other orders.

Order details 406 indicate that 468 items have been requested. Table 420 illustrates how inventory items may be allocated to fulfill the order based upon the available inventory described in table 410. The inventory items may be allocated using method 300 depicted in FIG. 3. Table 420 includes multiple rows and columns, the rows showing results at various stages from application of method and the columns identifying various pieces of information associated each record of table 420. As depicted in FIG. 4 table 420 includes the following columns: quantity to be allocated column 441, units of measure column 442, suggested quantity column 443, suggested locations column 444, items allocated column 445, and quantity remaining to be allocated column 446.

For each step, quantity to be allocated column 441 identifies a total number of inventory items that remain to be allocated to completely fulfill the order at the start of that step. At the start of the allocation process, as depicted by step 1 (row 451), this quantity is equal to the items requested in the order. This quantity goes down as items are allocated to the order.

For each step, units of measure column 442 indicates the number of inventory items that comprise each of the inventory sets allocated to the order in that step. For example, the units of measure for each bulk inventory item sets is 500 items, and the units of measure for each case inventory item sets is 50 items. This column thus identifies the inventory unit type (e.g., bulk, case, box, etc.) that is selected for allocation for the order. For example, in rows 451, 452, and 453 corresponding to steps 1, 2, and 3, inventory units of type case have been selected, in row 454 (step 4) inventory units of type box have been selected, and in row 455 (step 5) inventory units of type “each” are selected.

For each step, suggested quantity column 443 comprises a number identifying a number of inventory item sets (or units) identified by units of measure 442 that are suggested to be allocated to the order in that step. For example, 2 cases are suggested in step 1 (row 451), 4 cases are suggested in step 2 (row 452), 3 cases are suggested in step 3 (row 453), 1 box is suggested in step 4 (row 454), and 8 individual “each” items are suggested in step 5 (row 455).

For each step, suggested location(s) column 444 identifies a suggested physical location from which an inventory item set selected for that step could be allocated for example, for step 1 (row 451), 2 cases may be allocated from location C1.1.

For each step, items allocated column 445 identifies the number of inventory items allocated in that step, and quantity remaining to be allocated column 446 identifies the number inventory items that have still to be allocated to the order at the end of the step. For each row, items allocated column 445 may be determined by multiplying the values in columns 442 and 443. For each row, the quantity remaining to be allocated 446 may be determined by subtracting the value in column 445 from the value in column 441. For example, 100 items are allocated in step 1 (row 451) for the order and 368 items still remain to be allocated to fulfill the order at the end of step 1.

In one embodiment, processing for allocating items for an order (e.g., method 300 depicted in FIG. 3) may iterate through various steps until the value in quantity remaining to be allocated column 446 reaches zero (i.e., all the items requested in the order have been allocated). In an alternative embodiment where minimum and/or maximum threshold values are associated with the order, the processing may iterate until the thresholds are satisfied or the quantity remaining to be allocated to the order reaches zero. As described above, a minimum threshold indicates that the customer will accept less than the requested number of inventory units so long as the quantity of inventory units provided is greater than or equal to the minimum threshold value, while a maximum threshold indicates that the customer will accept more than the requested quantity of inventory units so long as the quantity of inventory units provided is less than or equal to the maximum threshold value. Furthermore, in some embodiments of the present invention, the minimum and maximum thresholds are only considered if the exact number of items requested in the request for inventory items may not be provided based upon available inventory.

At step 1 (row 451), which represents the start of the allocation processing, the quantity to be allocated 441 equals 468 items (the number of inventory items requested in order 406). A largest inventory item set whose size (i.e., the number of items included in the item set) is equal to or smaller than the quantity to be allocated 441 (468 in step 1) is selected in step 1. Since the order was for 468 items, skips the available bulk inventory item sets (stored in bulk warehouse zone 411) are skipped and available inventory cases inventory item sets (stored in case storage warehouse zone 412) are allocated, as indicated by value 50 (each inventory set in the “case” area comprises 50 items) in column 442. The inventory item sets in the bulk zone are not considered, because allocating bulk inventory item sets would require breaking the bulk inventory item sets into one or more subsets—a process that is labor intensive and to be avoided if possible.

Since table 410 indicates that there are 2 cases available in area C1.1, these two cases are suggested for selection in step 1, as indicated by column 443 and 444. Since each case holds 50 units, items allocated column 445 is determined by multiplying the number suggested quantity by the units of measure (2*50) for a total of 100 inventory items. The quantity remaining to be allocated 446 is then determined by subtracting the items allocated from the quantity to be allocated 441 (468−100) for a total of 368 inventory items remaining to be allocated in order to fulfill the order.

At step 2 (row 452), the quantity remaining to be allocated 446 from the previous step is carried over as the starting quantity to be allocated 441. Therefore, the starting quantity to be allocated 441 equals 368 inventory items at step 2. Four available cases located at C1.2 are suggested for selection. Once again, the “units of measure” 442 is equal to 50 indicating a case, and the suggested quantity is equal to 4. The items allocated equals 200, and the quantity remaining to be allocated equals 168.

At step 3 (row 453), the starting quantity to be allocated is carried over from the previous step, and 168 inventory items still need to be allocated in order to fulfill the order. Three available cases located at C1.4 are allocated for a total 150 inventory items allocated (3 cases*50 inventory items per case). The quantity remaining to be allocated 446 is 18 at the end of step 3.

At step 4 (row 454), the starting number of inventory items to be allocated is 18, which is smaller than the number of items stored in each case (each case includes 50 inventory items). Therefore, available content stored in the box inventory item sets in column 413 are considered for allocation, since each box comprises 10 inventory items. The units measure 442 is 10 inventory items per box, and the suggested quantity is 1 box. A box from location B1.2 is allocated, because location B1.2 had 4 boxes available at the start of step 4 based upon information in table 410. The items allocated column 445 equal 10 (1 case*10 inventory items per box). The quantity remaining to be allocated 446 equal 8 inventory items at the end of step 4.

At step 5 (row 455), the starting quantity to be allocated 441 equals 8 inventory items. Remaining number of inventory items to be allocated for the order is now less than the number of items stored per box (each box includes 10 inventory items), so available inventory are selected from the “each” storage locations of the warehouse where inventory items are stored separately. Units of measure 442 equals 1 for step 455, since individual inventory items are now being selected. Suggested quantity 443 equals 8 inventory items, and suggested location is E1.1 which had 96 individual inventory items available at the beginning of step 5. The items allocated equal 8, and the quantity of inventory items remaining to be allocated is decremented to zero.

Upon of step 5, a sufficient number of inventory items to fulfill the order in its entirety have been allocated. The inventory item sets allocated to the order will be marked as selected or unavailable for other orders. The suggested number of inventory item sets will then be picked from locations 444 associated with the suggestions to complete the order. The picked items may then be shipped to the order requester.

The information stored in table 410 is also updated after every step to reflect the latest information. For example, the value depicted in rows 404 and 405 may be updated to reflect inventory item sets that have been selected for allocation to the order.

FIG. 5 is a flowchart illustrating a method 500 for allocating indivisible inventory items to an order using a minimum deviation heuristic allocation method according to an embodiment of the present invention. Method 500 minimizes the number of picks required to fulfill the order while coming as close as possible to the quantity requested in the order based upon available inventory. Method 500 may be performed by software (e.g. computer program code) executed by a processor, by hardware, or a combination thereof.

Unlike the standard pack quantities or user-defined quantities described above, an indivisible inventory item cannot be subdivided into smaller subsets in order to fulfill an order. Each indivisible inventory item comprises one or more inventory units that have to be allocated as a whole, and is therefore treated as a single inventory item by the inventory management system. As described above, an inventory units value is associated with each indivisible inventory item. The inventory units value indicates a quantifiable size of each indivisible inventory item is used when selecting indivisible inventory items for possible allocation to a request for inventory items.

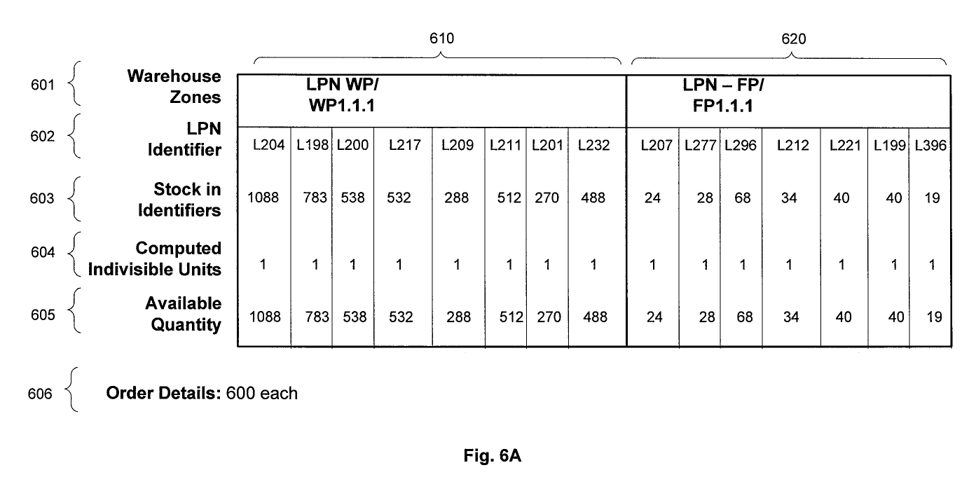

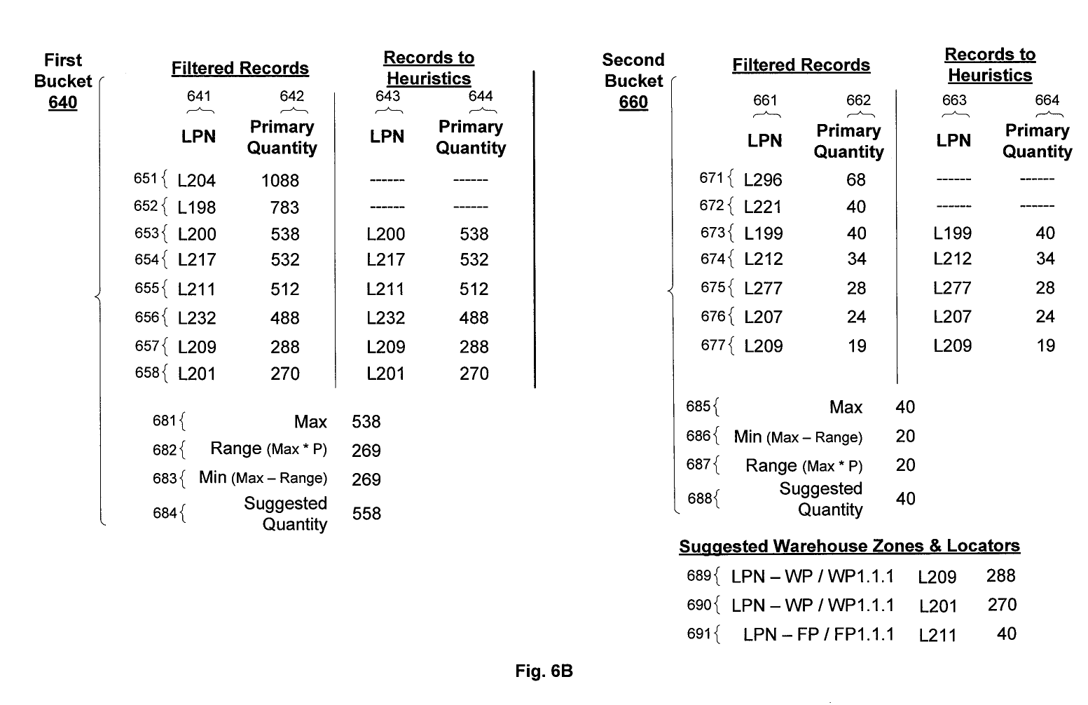

The available inventory items data may be grouped according to various criteria, such as LPN, physical storage location, etc. A set of records from the available inventory items data is referred to as a “bucket” and a minimum and maximum value is determined for each bucket. In the method embodiment depicted in FIG. 5, and in the examples depicted in FIGS. 6A and 6B, the available inventory items data is sorted into buckets by warehouse zone corresponding to the physical location of the inventory item in the warehouse and by the LPN of the indivisible inventory item. One skilled in the art will recognize that the available inventory item items information may be sorted according to criteria other than by physical location within the warehouse according to other embodiments of the present invention.

Method 500 begins with step 510 in which a bucket of data is selected from the available inventory items data. This bucket is referred to herein as the “current” bucket of data. The current bucket of data may be selected using various criteria. For example, the bucket of data may be selected based upon an average number of inventory units associated with indivisible inventory items represented by the records comprising the bucket of data.

Method 500 begins with step 520 in which a maximum number of inventory units for the current bucket is determined. As described above, each indivisible inventory item is associated with a number of inventory units that indicate the size of the indivisible inventory item. In step 520, the largest indivisible inventory item associated with a record in the bucket of data selected in step 510 is determined. The maximum for the bucket indicates the maximum number of inventory items that could be allocated if the largest indivisible inventory item associated with the bucket were allocated to the request. The maximum number of inventory units for the bucket will be used when determining which, if any, of the inventory items associated with the current bucket will be allocated to the order. Method 500 then proceeds to step 521.

At step 521, a minimum number of inventory units that might be selected for the current bucket is determined. The minimum number of inventory units is derived from the maximum number of inventory units determined in step 520. The minimum value for the bucket may be derived from the maximum value using a profile value or “P value” associated with the order. In an embodiment of the present invention, the P value is a percentage, and the minimum number of inventory units that may be considered for the current bucket is determined by multiplying the number of inventory units determined in step 520 by the P value. According to other embodiments of the present invention, the P value may defined on a per order basis, a per inventory item type basis, on a per customer basis, other criteria or a combination thereof.

At step 522, an indivisible inventory item associated with the records included in the current bucket of data is selected. The indivisible inventory item selected is associated with the maximum number of inventory units for the bucket (determined in step 520) and the selected inventory item is added to a suggested inventory items list. The suggested inventory items list comprises a list of indivisible inventory items that have been provisionally selected for allocation to the order. Indivisible inventory items added to the suggested inventory item list may be marked as “selected” in the inventory management system so that these items are not allocated to another order. If it is determined that the order can be fulfilled using the items inventory items in the suggested inventory items list, the inventory items in the list may be marked as “allocated” to indicate that the inventory items should be gathered (see steps 550 and 580 described below).

According to embodiments of the present invention, indivisible inventory items may be added to, removed from or replaced in the suggested inventory items list if a set of inventory items comprising a number of inventory units closer to the number of inventory units requested is identified during a subsequent iteration of method 500. In an embodiment of the present invention, a check may be performed at step 522 to determine whether the number of inventory units selected satisfies the order, and if the selected number of inventory items satisfies the order, method 500 proceeds to step 580.

At step 523, a suggested quantity of inventory units value is set to equal the number inventory units associated with the inventory item selected in step 522. The suggested quantity of inventory units value is used to track the sum of the number of inventory units associated with the currently selected inventory items. As method 500 progresses, additional inventory items may be selected and the suggested quantity of inventory units value would be incremented by the number of inventory units associated with these additional inventory items. Method 500 then proceeds to step 524.

At step 524, an indivisible inventory item associated with a next largest number of inventory units may be identified in the records included in the current bucket of data, where the indivisible inventory item has not yet been considered during a previous iteration of method 500. Method 500 then proceeds to step 525.

At step 525, the number of inventory units comprising the indivisible inventory item identified in step 524 are summed with the number of inventory units comprising the previous inventory item that was considered. If this is the first iteration through the records in the current bucket, then the previously considered inventory item is the inventory item having the maximum number of units selected at step 520. Method 500 continues with step 526.

At step 526, a determination is made whether the sum of the inventory units determined in step 525 is within a range of inventory units that would be accepted by the client for the order. According to some embodiments of the present invention, a customer may accept more of less units of a particular inventory item, with a specified range. A minimum and/or a maximum threshold may be provided for an order to be considered fulfilled or satisfied. A minimum threshold indicates a minimum number of inventory units that the client would accept if an exact number of inventory units requested in an order cannot be provided. A maximum threshold indicates a maximum number of inventory units that that the client would accept if an exact number of inventory units requested in an order cannot be provided. The minimum and/or maximum thresholds may be expressed as a number of inventory units in some embodiments of the present invention or may be expressed as a percentage of the number of inventory units requested in an order in other embodiments of the present invention. According to some embodiments, the upper and/or lower bounds of the range may be configurable on a per-customer and/or per-order basis.

If the sum of inventory units associated with the current and previous inventory items falls outside of the allowable range for the order, method 500 returns to step 524. Otherwise, method 500 continues with step 527.

At step 527, determination is made whether the sum of the inventory units determined in step 525 is greater than the suggested quantity of inventory units, which is equal to the sum of the inventory units of all of the inventory items in the suggested inventory items list. If the sum of the inventory units associated with the current and previous inventory items determined in step 525 is greater than the suggested quantity of inventory units, which indicates that the current and previous inventory items together provide a number inventory units that is closer to the requested number of inventory units than any inventory items that have been provisionally selected, method 500 continues with step 528 where the current and previous inventory items will be provisionally selected for allocation to the order and provisionally selected inventory items will be deselected. Otherwise, method 500 returns to step 524.

At step 528, the suggested inventory items list (described above with regard to step 522) is cleared and the status of any indivisible inventory items that were previously included in the suggested inventory items list is set to “available” to indicate that the inventory items are no longer provisionally selected for allocation to an order and that the inventory items may be selected for allocation for another order. Then the current indivisible inventory item and the previously considered inventory item are inserted into the suggested inventory items list and both inventory items are marked as “selected” to indicate that these items have been provisionally selected for allocation to an order and cannot be allocated to a different order. According to an embodiment of the present invention, the LPN associated with the current inventory item and the previous inventory items are inserted into the suggested inventory items list. Method 500 continues with step 529.

At step 529, suggested quantity of inventory units is set to equal the sum of the inventory units associated with the current inventory item and the previous inventory item. Method 500 continues with step 530.

At step 530, a determination is made whether the current bucket includes more inventory items that have not yet been considered. If there are not more records to be considered, method 500 continues with step 535. Otherwise, the method 500 returns to step 524, where a next largest indivisible inventory item is considered.

At step 535, a difference between the number of inventory units requested in the order and the suggested quantity of inventory units is determined.

At step 540, a determination is made whether the difference determined in step 535 is greater than zero. If the difference is zero, then the order has been completely fulfilled, and method 500 proceeds to step 580 where the selected inventory items will be allocated to the order. According to some embodiments, an order may also be fulfilled if the number of inventory units allocated to the order fall within a range of inventory units that would be accepted by the client for the order. Ranges are described in detail above with respect to step 526.

If the order has been completely fulfilled (the number of inventory units to be allocated to the equals the number of inventory units requested in the order) or the number of inventory units to be allocated to the order falls with an acceptable range for the order, then method 500 continues with step 580. Otherwise if the order has not been fulfilled, method 500 continues with step 565.

At step 565, a determination is made whether the available inventory items data includes additional buckets of data that have not yet been considered. If the available inventory items include additional buckets of data that have not yet been considered, method 500 returns to step 510 where a new current bucket is selected for consideration. Otherwise, if no more buckets of data remain to be considered, method 500 proceeds to step 570.

If there are additional indivisible inventory items that might be allocated to the order, then the processing continues with step 510. Otherwise, processing continues to step 570.

At step 570, an indication is provided that the order could not be fulfilled based upon the available inventory. According to an embodiment, if an order could not be fulfilled, a notification is generated for warehouse personnel and/or the customer that placed the order to indicate that the order could not be fulfilled at the present time. An order may, for example, not be able to be fulfilled due to a lack of inventory or, even when inventory is available, the currently available indivisible inventory items may fall outside of range limits that on the quantity of inventory units that the customer will accept for the order. After completing steps 570, method 500 terminates.

At step 580, the state of the currently selected inventory items is updated from “selected” to “allocated” indicating that the inventory items have been allocated to the current order being processed and should not be selected and/or allocated for use in fulfilling another order in the system. The list of allocated inventory items will be used to pick the inventory items from the storage locations in the warehouse and to prepare the order to be shipped to the client. After completing step 580, method 500 terminates. Various post-allocation processing may also be performed by the inventory management system. If the allocation process was successful, the allocated inventory items will be picked from the inventory, and the ordered items will be gathered and shipped to the customer.

According to some embodiments, method 500 may perform multiple iterations may be made through available inventory items when selecting inventory items from each bucket, which may result in method 500 determining a combination of inventory items that result in a number of inventory units closer to the requested quantity of inventory units. Furthermore, according to some embodiments, different combinations of inventory items and/or combination of more than two inventory items may be tested to determine if closer result may be obtained.

FIGS. 6A and 6B illustrate an example of using method 500 to allocate indivisible inventory items to fulfill an order for indivisible inventory items according to an embodiment of the present invention. FIG. 6A depicts a table comprising available indivisible inventory item information grouped by physical location within a warehouse. Section 610 comprises information about indivisible inventory items stored in a first physical location within a warehouse “LPN-WP/WP1.1.1” and section 620 comprises information about indivisible inventory items stored in a second physical location within a warehouse “LPN-FP/FP1.1.1.” Sections 610 and 620 comprise multiple columns and each column representing an indivisible inventory item that is associated with either the first or second physical location within the warehouse.

Row 601 identifies a physical location of indivisible inventory items within a zone of a warehouse or other storage facility. Row 602 identifies an LPN identifier of an indivisible inventory item. Row 603 identifies a stock in identifier value for each indivisible inventory item that indicates a number of inventory units that comprise the indivisible inventory item. Row 604 identifies computed indivisible units value for each indivisible inventory item. The computed indivisible units will always be equal to 1, because indivisible inventory items cannot be subdivided, unlike the standard pack quantities and user-defined quantities described above. Row 605 identifies an available quantity in inventory units value for each indivisible inventory item. Since indivisible inventory items cannot be subdivided, they must be allocated as a single unit. Therefore, the available quantity (row 605) will always be equal to the stock in identifiers (row 603).

Order details 606 indicate the number of units of an indivisible inventory item that have been ordered. As described above, indivisible inventory items may have a number of inventory units associated with them that identifies that is used when selecting indivisible inventory items for allocation to an order. An order for an indivisible inventory item may indicate a desired quantity of the indivisible inventory item in inventory units. One or more indivisible inventory items may be allocated to in response to the order. The sum of the inventory units associated with the one or more indivisible inventory items having a number of associated inventory units being equal to or within an allowable threshold of the number of inventory units requested in the order. For example, an order may include a request for 100 meters of steel cable, and in response to the order, a first indivisible inventory item comprising 60 meters of steel cable and a second indivisible inventory item comprising 40 meters of steel cable may be allocated in response to the order.

In the embodiment of the present invention illustrated in FIGS. 6A and 6B, an order for 600 inventory items has been placed, and it is assumed that the profile or “P” value associated with the order is 50%, a maximum threshold of 0% is provided (which indicates that the client will accept no more than the 600 units requested in the order), and a minimum threshold of 10% is provided (which indicates that the customer would accept no less than 540 inventory units or 90% of the requested number of inventory units).

FIG. 6B illustrates steps of the process of allocating indivisible inventory items from the indivisible inventory items identified in FIG. 6A to fulfill the order for 600 inventory units (order details 606). In response to the order for 600 units, available non-divisible inventory item information is accessed, and first bucket of data 640 is provided. The available inventory items have been filtered to eliminate at least some available inventory item information from consideration that does not meet the filter criteria (see step 222 of method 200 described above).

First bucket of data 640 includes filtered records section comprising an LPN column 641 and a primary quantity column 642 and a records to heuristics section comprising an LPN column 643 and a primary quantity column 644. The filtered records section of first bucket of data 640 includes records that have been accessed in response to the order. For each indivisible item, LPN column 641 identifies the LPN associated with the indivisible inventory item included in the filtered set of available inventory items data, and primary quantity column 642 identifies a number of inventory units that comprise the indivisible inventory item. The records to heuristic section of first bucket of data 640 comprises a subset of the filtered data from the filtered records section that is passed to method 500, described above, which attempts to allocate indivisible inventory items to an order. LPN column 643 identifies the LPN of an indivisible inventory item included in the set of available inventory items being passed to method 500 for possible allocation to an order, and primary quantity column 644 identifies a number of inventory units associated with each indivisible inventory item. The records in the present embodiment are sorted in descending order with inventory item a largest number of inventory units associated with them being located toward the top of the table.

Two records from the filtered records section of first bucket of data 640 are ignored by method 500 and are not included in the records to heuristic section of first bucket of data 640. The record for indivisible inventory item with LPN “L204” comprising 1088 inventory units (row 651) and the record for indivisible inventory item with LPN “L198” comprising 783 inventory units (row 652) are not passed on to method 500 because these indivisible inventory items have a number of inventory units associated with them that exceeds the number of inventory units requested in the order. As indicated above, order details 606 includes a request for 600 inventory units. According to some embodiments, indivisible inventory items having a number of inventory units associated with them that exceeds the number of inventory units requested may be also be considered if a maximum threshold has been defined for the order. However, in order simplify the example provided in FIGS. 6A and 6B and to more clearly illustrate the allocation process, only a minimum threshold indicating a minimum number inventory items that would be accepted is assumed to be applicable for the embodiment described herein. The indivisible inventory items associated with row 651-row 658 are passed on to the minimum deviation heuristic allocation method, because the primary quantity associated with the indivisible inventory items referenced by those rows does not exceed the number of inventory units requested in the order.

A maximum 538 (reference 681) and minimum 269 values (reference 683) are determined from the filtered records in section 641 (steps 520 and 521 of method 500). Maximum 681 is 538 inventory units (LPN “L200” of row 653). Range 682 is determined by multiplying maximum 681 by the profile value for the order. The profile value in the preset example is 50%. Thus, the value of range 682 equals 269 inventory units, which is 50% of 538 inventory units. The minimum that will be selected for the bucket is maximum 681 minus range 682. Thus, minimum 683 is equal to 269 inventory units. Suggested quantity 684 will now be determined by iterating though each of the records in the records to heuristic section of first bucket of data 640 using to method 500.

Suggested quantity 684 indicates the suggested quantity of inventory units to be allocated to the order. Suggested quantity 684 is initially set to the number of inventory units associated with record “L200” and LPN “L200” is then added to the suggested inventory items list (steps 522 and 523 of method 500).

The remaining inventory items in first bucket of data 410 are then considered to determine whether a set of inventory items having a sum of inventory units associated with the set of inventory items that is closer to the number of inventory units requested is determined. Row 654 is considered next (step 524). The inventory item of row 654 has been assigned LPN “L217” and 532 inventory units are associated with this inventory item. The number of inventory units associated with the current record (row 654) is added to the number of inventory items associated with the previous record (row 653). The current record (row 654) is associated with 532 inventory units and the previous record (row 653) is associated with 538 inventory units. The sum of the number of inventory items associated with the current and previous records is 1070 inventory units. A determination is made whether this is within the allowable range (step 526). Here, the sum exceeds the number of units requested (order details 606), so processing continues with the next record (step 524 of method 500).

As described above, embodiments may perform multiple iterations over each bucket of the available inventory items, which may result in a combination of inventory items that are associated with a number of inventory units closer to the requested quantity of inventory units. Furthermore, according to some embodiments, different combinations of inventory items and/or combination of more than two inventory items may be tested to determine if closer result may be obtained.

Row 655 is considered next (step 524). The inventory item of row 655 has been assigned LPN “L211” and 512 inventory units are associated with this inventory item. The number of inventory units associated with the current record (row 655) is added to the number of inventory items associated with the previous record (row 654). The current record (row 655) is associated with 512 inventory units and the previous record (row 654) is associated with 532 inventory units. The sum of the inventory units associated with the current and previous records is 1044 inventory units. This sum exceeds the number of units requested, so processing continues with the next record (step 526).

Row 656 is considered next (step 524). The inventory item of row 656 has been assigned LPN “L232” and comprises 488 inventory units. The number of inventory units associated with the current record (row 656) is added to the number of inventory items associated with the previous record (row 655). The current record (row 656) is associated with 488 inventory units and the previous record (row 655) is associated with 512 inventory units. The sum of the inventory units associated with the current and previous records is 1000 inventory units. This sum exceeds the number of units requested, so processing continues with the next record (step 526).

Row 657 is considered next (step 524). The inventory item of row 657 has been assigned LPN “L209” and comprises 288 inventory units. The number of inventory units comprising the associated with record (row 657) is added to the number of inventory items associated with the previous record (row 656). The current record (row 657) is associated with 288 inventory units and the previous record (row 656) is associated with 488 inventory units. The sum of the inventory units associated with the current and previous records is 776 inventory units. This sum exceeds the number of units requested, so processing continues with the next record (step 526).

Row 658 is considered next (step 524). The inventory item of row 658 has been assigned LPN “L201” and comprises 270 inventory units. The number of inventory units associated with the current record (row 658) is added to the number of inventory items associated with the previous record (row 657). The current record (row 658) is associated with 270 inventory units and the previous record (row 657) is associated with 288 inventory units. The sum of the number of inventory units associated with the current and previous records is 558 inventory units. The sum of the inventory units associated with the current and previous inventory items is less than then number of inventory units remaining to be allocated to the order, so a determination is made whether the sum of the inventory items associated with the current and previous records exceeds the current value of the suggested quantity (step 527). The value of the suggested quantity is currently 538 inventory units (row 653). Since 558 inventory units exceeds the current suggested quantity of 538 inventory units, the suggested quantity is updated to 538 inventory units (step 528) and the suggested inventory items list is cleared and the LPNs of the current and previous record (LPN “L209” and “L201”) are inserted into the suggested inventory items list.

No more inventory items remain in first bucket of data 640 to be considered (step 530), so a determination is made as to the remaining number of inventory items requested for which inventory items have not yet been selected (step 535). The order requested 600 inventory items and 558 inventory items were selected from first bucket 640. Therefore, 42 inventory items remain to be allocated for the order. According to some embodiments, if the number of inventory units allocated to the order exceeds a minimum threshold associated with the order, the order may be determined to be fulfilled, the selected inventory items will be allocated to the order, and the selection process will terminate.

Once processing of first bucket 640 has been completed, an additional bucket of records from the available inventory items data may be considered where the records include a primary quantity less than or equal to the remaining number of inventory items to be allocated (step 560). Second bucket 660 represents a group of records from warehouse zone “LPN-FP/FP1.1.1” illustrated in section 620 of FIG. 6A.

Processing for second bucket 660 operates similarly to that described for first bucket 640. A maximum and minimum are determined for the bucket (steps 520 and 521). Maximum 685 is equal to 40 inventory units. The records in second bucket 660 are sorted by primary quantity in descending order. The record in row 671 is not passed on to the minimum deviation heuristic method for consideration because the primary quantity of 68 inventory items exceeds the remaining number of inventory items to be allocated for the order. Maximum 685 is determined to be 40 inventory items and minimum 687 is determined to be 20 inventory items. Suggested quantity 688 is set to 40 inventory items and LPN 221 is inserted into the suggested inventory items list.

The remaining inventory items from second bucket 660 are now considered to see if the sum of multiple inventory items will exceed the current suggested quantity while not exceeding the number of inventory items requested. Row 673 is considered next (step 524). The inventory item of row 654 has been assigned LPN “L199” and 40 inventory units are associated with the inventory item. The number of inventory units associated with the current record (row 673) is added to the number of inventory items associated with the previous record (row 672). The current record (row 673) is associated with 40 inventory units and the previous record (row 672) is associated with 40 inventory units. The sum of the inventory units associated with the current and previous records is 80 inventory units. A determination is made whether this sum is within the allowable range (step 526). This sum of 80 inventory units exceeds the number of units remaining to be allocated (42 inventory units), so processing continues with the next record (returns to step 524).

Row 674 is considered next (step 524). The inventory item of row 674 has been assigned LPN “L212” and 34 inventory units are associated with the inventory item. The number of inventory units associated with the current record (row 674) is added to the number of inventory units associated with the previous record (row 673). The current record is associated with 34 inventory units and the previous record is associated with 40 inventory units. The sum of the inventory units associated with the current and previous records is 74 inventory units. This sum exceeds the number of units remaining to be allocated (42 inventory units), so processing continues with the next record (step 526).

Row 675 is considered next (step 524). The inventory item of row 675 has been assigned LPN “L277” and 28 inventory units are associated with the inventory item. The number of inventory units associated with the current record (row 675) is added to the number of inventory items associated with the previous record (row 674). The current record (row 675) is associated with 28 inventory units and the previous record (row 674) is associated with 34 inventory units. The sum of the inventory units associated with the current and previous records is 62 inventory units. This sum exceeds the number of units remaining to be allocated (42 inventory units), so processing continues with the next record (step 526).

Row 676 is considered next (step 524). The inventory item of row 676 has been assigned LPN “L207” and 24 inventory units are associated with the inventory item. The number of inventory units associated with the current record (row 676) is added to the number of inventory items associated with the previous record (row 675). The current record (row 676) is associated with 24 inventory units and the previous record (row 675) is associated with 28 inventory units. The sum of the inventory units associated with the current and previous records is 52 inventory units. This sum exceeds the number of units remaining to be allocated (42 inventory units), so processing continues with the next record (step 526).

Row 677 is considered next (step 524). The inventory item of row 677 has been assigned LPN “L209” and 19 inventory units are associated with the inventory item. The number of inventory units associated with the current record (row 677) is added to the number of inventory items associated with the previous record (row 676). The current record (row 677) is associated with 19 inventory units and the previous record (row 676) is associated with 24 inventory units. The sum of the inventory units associated with the current and previous records is 43 inventory units. This sum exceeds the number of units remaining to be allocated (42 inventory units), so processing continues with the next record (step 526).

No more records remain in second bucket 660 to be considered. Suggested quantity 684 from first bucket 668 comprises 558 inventory units and suggested quantity 688 from second bucket 660 comprises 40 inventory units. The total suggested number of inventory units is 598 inventory items units. The suggested number of inventory units is less than the number of inventory units requested, but the values returned are within the acceptable range associated with the order. The minimum threshold for the order was 540 inventory units. Therefore, the results of the allocation process comprise three indivisible inventory items: LPN “L208” which has 288 inventory units associated with it (row 689), LPN “L201” which has 270 inventory units associated with it (row 690), and LPN “L221” which has 40 inventory units associated with it (row 271) are allocated to the order.

According to an embodiment of the present invention, each of the three indivisible inventory items selected above will be marked as “allocated” so that these indivisible inventory items will not be allocated to another order. The selected indivisible inventory items are also be identified in a notification to warehouse personnel and/or an automatic picking system which pick the indivisible inventory items identified by the LPNs stored in the suggested inventory items list.

FIG. 7 is a simplified block diagram of an inventory management system 700 incorporating an embodiment of the present invention. Inventory management system 700 includes workstations 705A and 705B, inventory management database 730, and inventory management computer system 710. Workstations 705A and 705B may be computer systems, such as a desktop workstation, a laptop computer, or a handheld computing device. Workstations 705A and 705B may include I/O devices for receiving user input (e.g., via a keyboard, mouse, etc.) and a outputting information to a user (e.g., via a display and/or a video output). In one embodiment, interfaces provided by inventory management system 700 may be displayed to the user using workstations 705A and/or 705B.

Inventory management system 700 depicted in FIG. 7 is merely illustrative of an embodiment incorporating the present invention and does not limit the scope of the invention as recited in the claims. One of ordinary skill in the art would recognize other variations, modifications, and alternatives. For example, the present invention may also be embodied in a stand-alone system where the functionality of workstations 705A and 705B is integrated into inventory management system 700. In a stand-alone environment, the functions performed by the various computer systems depicted in FIG. 7 may be performed by a single computer system.

Network 750 provides a mechanism allowing the various computer systems depicted in FIG. 7 to communicate and exchange information with each other. Network 750 may itself be comprised of many interconnected computer systems and communication links. While in one embodiment, Network 750 is the Internet, in other embodiments, network 750 may be any suitable communication network including a local area network (LAN), a wide area network (WAN), a wireless network, an intranet, a private network, a public network, a switched network, or the like.

Communication links 770 used to connect the various systems depicted in FIG. 7 may be of various types including hardwire links, optical links, satellite or other wireless communications links, wave propagation links, or any other mechanisms for communication of information. Various communication protocols may be used to facilitate communication of information via the communication links. These communication protocols may include TCP/IP, HTTP protocols, extensible markup language (XML), wireless application protocol (WAP), protocols under development by industry standard organizations, vendor-specific protocols, customized protocols, and others.

According to other embodiments, inventory management computer system 710 may provide software and/or a user interface to be displayed by workstations 705A and 705B. For example, inventory management computer system 700 may comprise a web server and the user interface of the inventory management system may comprise web pages. The software and/or user interface provided by inventory management computer system 710 may also be configured to receive orders for inventory items entered via workstations 705A and 705B and to provide information about the status of order to workstations 705A and 705B, such as whether an order was able to be fulfilled using available inventory.

Inventory management database 730 is a persistent data storage, such as a relational database system. Inventory management database 730 may be used to store information related to inventory, orders and/or customer information. For example, inventory management database 730 may be used to store information about available inventory in a warehouse. Customer information, such as shipping and billing information, and/or other information, such as customer order preferences may also be stored in inventory management database 730. Other information such as order information regarding pending and/or completed orders may also be stored in inventory management database 730. Inventory management database 730 further comprises an interface for accessing and/or modifying data stored in inventory management database 730, such as via SQL and/or another query language. In some embodiments, inventory management database 830 may be implemented as a separate relational database system that is communicatively connected to connected either directly or indirectly (such as through network 750) to inventory management computer system 710, while in other embodiments, inventory management database 830 may be integrated into inventory management computer system 710.

One skilled in the art will recognize that inventory management system 700 is merely exemplary and that other configurations are also possible and that embodiments of the present invention are not limited to the configuration illustrated in FIG. 7. For example, according to some embodiments, workstations 705A and 705B may communicate directly with inventory management database 730.

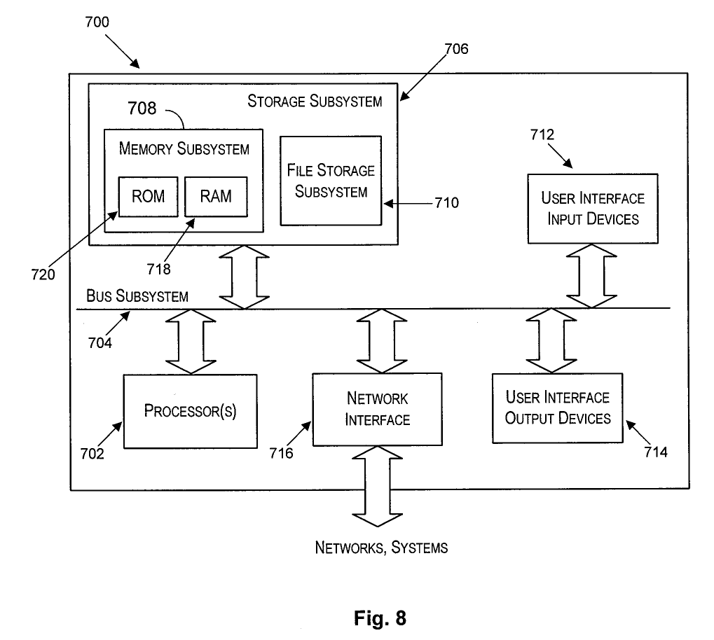

FIG. 8 is a simplified block diagram of a computer system that may be used to implement inventory management computer system 710 and/or workstations 805A and 805B according to an embodiment of the present invention. As shown in FIG. 8, computer system 800 includes a processor 802 that communicates with a number of peripheral subsystems via a bus subsystem 804. These peripheral subsystems may include a storage subsystem 806, comprising a memory subsystem 808 and a file storage subsystem 810, user interface input devices 812, user interface output devices 814, and a network interface subsystem 816.

Bus subsystem 804 provides a mechanism for letting the various components and subsystems of computer system 800 communicate with each other as intended. Although bus subsystem 804 is shown schematically as a single bus, alternative embodiments of the bus subsystem may utilize multiple busses.

Network interface subsystem 816 provides an interface to other computer systems, networks, and portals. Network interface subsystem 816 serves as an interface for receiving data from and transmitting data to other systems from computer system 800.

User interface input devices 812 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 700.

User interface output devices 814 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 806 may be configured to store the basic programming and data constructs that provide the functionality of the present invention. Software (programs, code modules or instructions) that provides the functionality of the present invention may be stored in storage subsystem 806. These software modules or instructions may be executed by processor(s) 802. Storage subsystem 806 may also provide a repository for storing data used in accordance with the present invention. Storage subsystem 806 may comprise memory subsystem 808 and file/disk storage subsystem 810.

Memory subsystem 808 may include a number of memories including a main random access memory (RAM) 818 for storage of instructions and data during program execution and a read only memory (ROM) 820 in which fixed instructions are stored. File storage subsystem 810 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 800 can be of various types including a personal computer, a portable computer, a workstation, a network computer, a mainframe, a kiosk, a server or any other data processing system. Due to the ever-changing nature of computers and networks, the description of computer system 800 depicted in FIG. 8 is intended only as a specific example for purposes of illustrating the an embodiment of a computer system that may be used to implement the present invention. Many other configurations having more or fewer components than the system depicted in FIG. 8 are possible.

While the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable media for storage and/or transmission; suitable media include magnetic disk or tape, optical storage media such as compact disk (CD) or DVD (digital versatile disk), flash memory, and the like. Such programs may also be encoded and transmitted using carrier signals adapted for transmission via wired, optical, and/or wireless networks conforming to a variety of protocols, including the Internet. Computer readable media encoded with the program code may be packaged with a compatible device or provided separately from other devices (e.g., via Internet download).

Thus, although the invention has been described with respect to specific embodiments, it will be appreciated that the invention is intended to cover all modifications and equivalents within the scope of the following claims.

What is claimed is:

1. A method of allocating inventory comprising:
receiving a request for one or more inventory items;
accessing available inventory information identifying a plurality of inventory items available for fulfilling the request, the plurality of inventory items being grouped into one or more inventory item sets, each inventory item set comprising one or more inventory items, wherein a divisibility indicator is associated with each inventory item set indicating whether a breakup of the inventory item set into one or more subsets is permitted;
selecting inventory item sets from the inventory information that may be used to fulfill the inventory request with a minimum number of inventory item sets; and
outputting the inventory sets to be gathered to fulfill the request.

2. The method of claim 1 wherein selecting inventory item sets from the inventory information that may be used to fulfill the inventory request with a minimum number of inventory item sets further comprises:
executing a selection method to select one or more inventory item sets that may be used to satisfy the order with a minimum number of inventory item sets.

3. The method of claim 2 wherein the selection method comprises a minimum deviation heuristic allocation method or a greedy allocation method.

4. The method of claim 3 wherein the greedy allocation method is used as the selection method as the selection method when the one or more inventory items requested in the request are stored in standard pack quantities or in user-grouped sets of inventory items.

5. The method of claim 4 wherein selecting inventory item sets from the inventory information that may be used to fulfill the inventory request with a minimum number of inventory item sets further comprises:
selecting a standard pack quantity or a user-grouped set of inventory items to be divided one or more subsets if an order cannot be satisfied using available inventory item sets;
dividing the standard pack quantity or the user-grouped set of inventory items into a plurality of subsets; and
selecting at least one of the subsets to be used to fulfill the inventory request.

6. The method of claim 3, wherein the minimum deviation heuristic allocation method is used as the selection method when the one or more inventory items requested in the request comprise indivisible inventory items.

7. An inventory management system, wherein the inventory management system is configured to:
receive a request for one or more inventory items;
access available inventory information identifying a plurality of inventory items available for fulfilling the request, the plurality of inventory items being grouped into one or more inventory item sets, each inventory item set comprising one or more inventory items, wherein a divisibility indicator is associated with each inventory item set indicating whether a breakup of the inventory item set into one or more subsets is permitted;
determine inventory item sets from the inventory information that may be used to fulfill the inventory request with a minimum number of inventory item sets; and
output the inventory sets to be gathered to fulfill the request.

8. The inventory management system of claim 7 wherein the inventory management system, being configured to determine inventory item sets from the inventory information that may be used to fulfill the inventory request with a minimum number of inventory item sets further, is further configured to:
executing a selection method to select one or more inventory item sets that may be used to satisfy the order with a minimum number of inventory item sets.

9. The inventory management system of claim 8 wherein the selection method comprises a minimum deviation heuristic allocation method or a greedy allocation method.

10. The inventory management system of claim 9 wherein the inventory management system is configured to use the greedy allocation method as the selection method when the one or more inventory items requested in the request are stored in standard pack quantities or in user-grouped sets of inventory items.

11. The inventory management system of claim 10 wherein the inventory management system, being configured to determine inventory item sets from the inventory information that may be used to fulfill the inventory request with a minimum number of inventory item sets, is further configured to:
select a standard pack quantity or a user-grouped set of inventory items to be divided one or more subsets if an order cannot be satisfied using available inventory item sets;
divide the standard pack quantity or the user-grouped set of inventory items into a plurality of subsets; and
select at least one of the subsets to be used to fulfill the inventory request.

12. The inventory management system of claim 9 wherein the inventory management system is configured to use the minimum deviation heuristic allocation method as the selection method when the one or more inventory items requested in the request comprise indivisible inventory items.

13. A computer readable medium storing a plurality of instructions for controlling a data processor to perform one or more tasks, the plurality instructions comprising:
an instruction that causes the data processor to receive a request for one or more inventory items;
an instruction that causes the data processor to access available inventory information identifying a plurality of inventory items available for fulfilling the request, the plurality of inventory items being grouped into one or more inventory item sets, each inventory item set comprising one or more inventory items, wherein a divisibility indicator is associated with each inventory item set indicating whether a breakup of the inventory item set into one or more subsets is permitted;
an instruction that causes the data processor to determine inventory item sets from the inventory information that may be used to fulfill the inventory request with a minimum number of inventory item sets; and
an instruction that causes the data processor to output the inventory sets to be gathered to fulfill the request.

14. The computer readable medium of claim 13 wherein the instruction that causes the data processor to determine inventory item sets from the inventory information that may be used to fulfill the inventory request with a minimum number of inventory item sets further comprises:
an instruction that causes the data processor to execute a selection method to select one or more inventory item sets that may be used to satisfy the order with a minimum number of inventory item sets.

15. The computer readable medium of claim 14 wherein the selection method comprises a minimum deviation heuristic allocation method or a greedy allocation method.

16. The computer readable medium of claim 15 wherein the greedy allocation method is used as the selection method when the one or more inventory items requested in the request are stored in standard pack quantities or in user-grouped sets of inventory items.

17. The computer readable medium of 16 wherein the instruction that causes the data processor to determine inventory item sets from the inventory information that may be used to fulfill the inventory request with a minimum number of inventory item sets further comprises:
an instruction that causes the data processor to select a standard pack quantity or a user-grouped set of inventory items to be divided one or more subsets if an order cannot be satisfied using available inventory item sets;
an instruction that causes the data processor to divide the standard pack quantity or the user-grouped set of inventory items into a plurality of subsets; and
an instruction that causes the data processor to select at least one of the subsets to be used to fulfill the inventory request.

18. The computer readable medium of 15 wherein the minimum deviation heuristic allocation method is used as the selection method when the one or more inventory items requested in the request comprise indivisible inventory items.
